(19) United States
(12) Patent Application Publication
(10) Pub. No.: US 2007/0044063 A1
(43) Pub. Date: Feb. 22, 2007

(54) Method for estimating voltage droop on an ASIC

(76) Inventor: Fouad A. Faour, Wellington, CO (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/208,678

(22) Filed: Aug. 22, 2005

(51) Int. Cl. G06F 17/50

(52) U.S. Cl. 716/16

(57) ABSTRACT

A simulation circuit model for a region of interest in an integrated circuit chip design is constructed that has a number of tiled, substantially identical sub-region simulation circuit models, each representing the supply voltage (V_{DD}) distribution network in one of a number of corresponding sub-regions of the region. This mosaic of sub-region simulation circuit models is provided to an electronic simulator tool such as SPICE so that supply voltage properties in a selected one of the sub-regions can be analyzed.

### DESCRIPTION OF THE RELATED ART

As application-specific integrated circuit (ASIC) designs have become more complex, design issues associated with power distribution on the chip have become more important. For example, the more complex chip designs consume more power than previous designs, which in turn increases the current delivered to the circuit (logic) elements. Large transients may occur in the power supply network due to switching events and instantaneous changes in current. A reduction in the supply voltage (V_{DD}) due to the change in current is known as a “voltage droop.” Severe voltage droops can cause adverse circuit operation. Voltage droop is typically worst at regions of the chip farthest from the solder bumps through which power is supplied to the chip through the chip packaging.

Designing an ASIC (or, for that matter, any other type of integrated circuit chip) involves a number of steps. Early in the process, functional specifications and performance requirements are developed. Then, the logic (circuit) design is developed. Finally, the circuit elements and interconnections are laid out to produce the artwork that will ultimately be used to fabricate the chip. At various points in the design process, simulations are performed using electronic design tools to determine if the design meets the functional specifications and performance requirements. If the simulation results are not satisfactory, changes are made to the design, and further simulations are performed.

Simulations relating to power distribution issues may require a current sink model. Current sink models can be static and otherwise straightforward or they can be dynamic (i.e., a waveform representing current over time) and more complex. Creating an accurate, dynamic current sink model requires that the design be fairly complete. For example, an accurate current sink model can be obtained by running simulations through extracted R-C (resistance-capacitance) values and gates, which requires that at least a preliminary form of the entire ASIC artwork have been completed. A primary advantage of a more straightforward or simpler model is that it can be incorporated into the simulations earlier in the design process. For example, a simple current sink model for a core region or other area of interest can be created by estimating the total power consumed by the entire ASIC and then attributing a portion of the total power to that region, based upon an assumption that power is distributed uniformly over the chip. A simple, static model based upon such (likely inaccurate) assumptions will almost certainly be less accurate than a model based upon actual design parameters. Nevertheless, as noted above, the conventional modeling method, involving running simulations through extracted R-C (resistance-capacitance) values and gates, cannot be performed early in the design process. In addition, the method is relatively slow.

Other types of simulations similarly suffer from the shortcoming that they cannot readily be performed early in the ASIC design process because they rely in part upon completed artwork. For example, voltage droop is conventionally analyzed by running simulations through extracted R-C (resistance-capacitance) values and logic gates. This method not only requires a completed logic design and artwork but also is relatively slow.

It would be desirable to provide an accurate ASIC current sink model that can be used in relatively fast simulations at an early stage in the design process. It would similarly be desirable to provide a model for performing relatively fast voltage droop analyses at such an early stage. The present invention addresses the above-described problems and deficiencies and others in the manner described below.

### SUMMARY OF THE INVENTION

The present invention relates to electronic design automation (EDA) simulations for integrated circuit chip designs, such as ASIC designs, that include a current sink model. An example of such a simulation is one that is used to analyze voltage droop.

In accordance with one aspect of the invention, a current sink model is provided by determining the charge consumed by each type of a predetermined group of standard cell types under each of a plurality of conditions, determining the quantity of such standard cells of each type in the region of interest on the chip, and then using the charge consumption and quantity of standard cells of each type to create a waveform representing current over time. The charge consumed can be determined by, for example, using SPICE or any other suitable circuit simulator tool.

The standard cell types can include, for example, registers, combinational logic gates, and buffers. The plurality of conditions can include, for example, rising and falling edges of the clock, logic transitions of registers and combinational logic, and combinations thereof.

In an exemplary embodiment of the invention, a script or tool can be provided that can receive as input from an ASIC designer or other user parameters such as: the percentage of the region that is occupied by the standard cells; the percentage of standard cells in the region that can be expected to switch logic values during any given clock cycle; and the estimated ratio of combinational to non-combinational logic in the region. A chip designer will know or can estimate these percentages at an early stage in the design process even though he or she may not yet have completed the logic design.

In an exemplary embodiment of the invention, the current waveform can be created in segments, with a first segment representing the charge consumption (and thus current sink behavior) of clock buffers at a rising edge of the clock, a second segment representing charge consumption of registers during a rising clock edge, and successive waveform segments representing charge consumption of combinational logic while switching state. The segment at the midpoint of the current waveform, i.e., the falling edge of the clock, can be created in response to charge consumption of clock buffers during the falling clock edge plus charge consumption of combinational logic that is switching state. The segment immediately following that at the midpoint can be created in response to charge consumption of registers during the falling clock edge plus charge consumption of combinational logic that is switching state. In this manner, segments representing the waveform over an entire clock cycle can be created.

A conventional EDA circuit design tool or simulator can then be used in the conventional manner to create a current sink model having that waveform. Using such a tool, the current sink model can be incorporated into an overall model of the chip for performing simulations.

In accordance with another aspect of the invention, the current sink model can be included in simulations for analyzing such chip design issues as the supply voltage droop that can be predicted or estimated to occur at one or more regions of interest on the chip. In accordance with an exemplary method for analyzing voltage droop, a region simulation circuit model is first created or otherwise provided. The region simulation circuit model comprises a number of tiled, substantially identical sub-region simulation circuit models, each representing the supply voltage (V_{DD}) distribution network (i.e., the metal supply voltage lines or tracks) in one of a number of corresponding sub-regions of the region. The sub-region simulation circuit models are made identical or at least substantially identical to simplify the calculations and simulation, so that they can be performed quickly and easily at an early stage in the design process. Thus, in other words, there is a representative sub-region simulation circuit model that is tiled, i.e., repeated, over all or substantially all of the sub-regions in the region. This mosaic of sub-region simulation circuit models forms or defines the overall (region) simulation circuit model that can then be provided to an electronic simulator tool.

An ASIC designer can select the number of lines to be dedicated to the supply voltage (V_{DD}). Therefore, in an exemplary embodiment of the invention, a script or tool can be provided that allows a user to input the number of lines or tracks on a layer that are to be dedicated to the supply voltage. A chip designer or other user who wishes to compare different chip design options at an early stage in the design process can thus run several simulations, each with a different number of supply voltage lines. The user can also vary other design parameters pertaining to the supply voltage distribution network and chip circuitry (logic). For example, the user can also vary any of the parameters noted above with regard to the current sink model. Such a script or tool can also provide the model to the simulator, control the simulation, and output the voltage waveform results, as well as perform calculations based upon the output waveform, such as calculating the average supply voltage droop at a node over a selected period of time such as one clock period.

Each sub-region simulation circuit model comprises resistors and capacitors representative of the resistances and capacitances of supply voltage lines in the representative sub-region based upon supply voltage line layout in the representative sub-region and predetermined resistance and capacitance per unit area of the chip. The resistors and capacitors representative of supply voltage line resistances and capacitances can be arranged in a pi (π) configuration or topology, as known in the art.

In a typical ASIC design, the supply voltage lines are distributed over more than one layer of the chip. The interconnections between supply voltage lines in adjacent layers in the representative sub-region can also be included in the representative sub-region simulation circuit model. If included in an embodiment of the invention, they can be modeled in any suitable manner, but in an exemplary embodiment they are maximized. That is, the maximum number of inter-layer metal contacts (or “vias,” as they are typically known in the art) that can be fit, within predetermined design parameters, into the area where supply voltage lines in adjacent layers cross one another is calculated, and their resistances are determined and included in the representative sub-region simulation circuit model.

Once the region simulation circuit model has been provided, a suitable EDA simulator tool, such as SPICE, is used to determine the supply voltage waveform at a node in one of the sub-region simulation circuit models. Although any sub-region in the region can be selected for simulation of the supply voltage waveform there, the sub-region farthest from a supply voltage solder bump would typically experience the greatest voltage droop and would therefore most likely be of greatest interest to an ASIC designer.

### BRIEF DESCRIPTION OF THE DRAWINGS

FIG. 1 conceptually illustrates a workstation computer on which an ASIC can be designed using tools such as an ASIC design tool, a simulator tool, and one or both of the novel current sink modeler and voltage droop modeler tools of the present invention.

FIG. 2 illustrates examples of standard cells used in an exemplary embodiment of the present invention to provide a current sink model.

FIG. 3 is a flow diagram illustrating an exemplary method for providing a current sink model for the power supply voltage (V_{DD}).

FIG. 4 illustrates an exemplary current sink waveform drawn from V_{DD} by one type of standard cell, a flip-flop.

FIG. 5 illustrates an exemplary current sink waveform drawn from V_{DD} by another type of standard cell, a NAND gate.

FIG. 6 illustrates an exemplary current sink waveform drawn from V_{DD} by still another type of standard cell, a clock buffer.

FIG. 7 illustrates a power supply current sink waveform and method for determining it in response to charge consumption and quantity of standard cells of each type during each of a plurality of waveform segments.

FIG. 8 is a diagram of the supply voltage (V_{DD}) bumps and ground bumps on a portion of an ASIC.

FIG. 9 is a diagram of a region of the ASIC divided into sub-regions in accordance with an exemplary method for providing a voltage model for a region of an integrated circuit chip.

FIG. 10 is a flow diagram illustrating an exemplary method for providing a voltage model for a region of an integrated circuit chip.

FIG. 11 is a flow diagram illustrating an exemplary method for providing a representative sub-region simulation circuit model.

FIG. 12 illustrates two exemplary layers of the power distribution network in a sub-region.

FIG. 13 is an enlargement of a portion of FIG. 12, showing vias connecting two supply voltage lines in adjacent layers in the sub-region.

FIG. 14 is a schematic diagram of a generalized pi-network circuit representing the resistances and capacitances of a supply voltage line.

FIG. 15 is a schematic diagram of representative sub-region simulation circuit model.

FIG. 16 illustrates an exemplary voltage waveform at a selected node of the circuit model in a selected sub-region.

### DETAILED DESCRIPTION OF PREFERRED EMBODIMENTS

In the following description, like reference numerals indicate like components to enhance the understanding of the invention through the description of the drawings. Also, although specific features, configurations, arrangements and steps are discussed below, it should be understood that such specificity is for illustrative purposes only. A person skilled in the relevant art will recognize that other features, configurations, arrangements and steps are useful without departing from the spirit and scope of the invention.

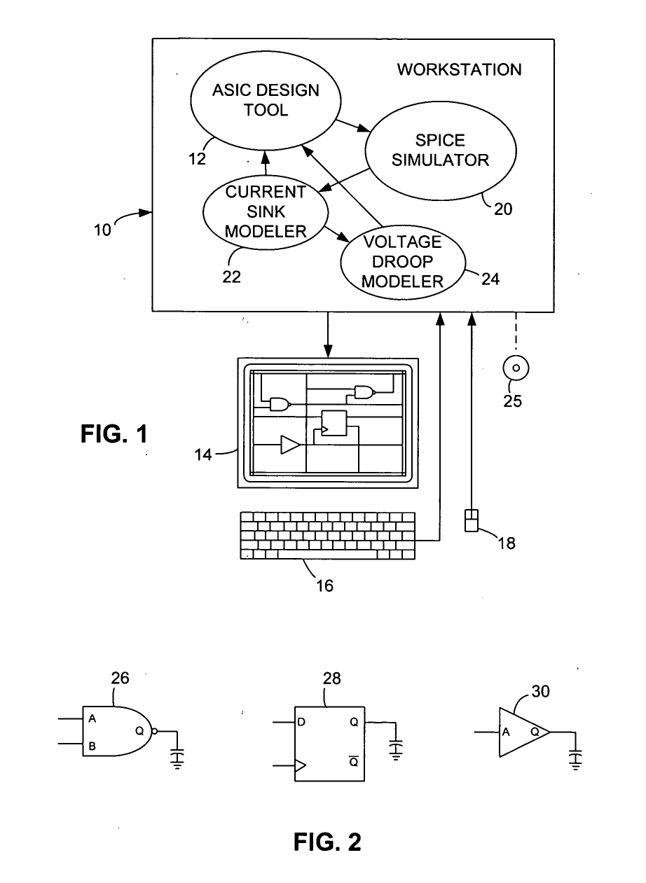

As illustrated in FIG. 1, an ASIC designer working on a conventional computer 10 can use various electronic design automation (EDA) software tools to design an ASIC, perform simulations, and perform other tasks relating to designing and producing an ASIC. For example, a conventional ASIC design tool 12 or tool set can be used to build a circuit model by selecting and interconnecting gates and other circuit elements, placing the elements in the desired physical relationship with one another, and routing the interconnecting signal and power lines. Although in many instances, some of these functions may be performed on another computer or by another party using separate software tools (e.g., by a party charged with manufacturing the ASIC), such tools are shown as a unitary ASIC design tool 12 running on computer 10 for purposes of illustration and clarity. Similarly, it should be recognized that these tools and those described below as running on computer 10 are shown in this conceptual manner for purposes of illustration only; as persons skilled in the art to which the invention relates will understand, software elements may reside on other computers networked to computer 10 or may even be distributed among multiple computers at different locations that are not necessarily networked to one another. Accordingly, computer 10 can be a single computer (e.g., of the type commonly known as a workstation) or, alternatively, it can comprise multiple computers, servers, terminals and similar elements familiar to persons skilled in the art. Similarly, individual aspects of the present invention (e.g., method steps and functional software modules that embody them) can be used in different locations and at different times on different computers by different persons.

In any event, as illustrated in generalized form in FIG. 1, such tools typically have graphical user interfaces that show the circuitry, line routing, or other features of interest on a display 14 associated with one of the computers. The ASIC designer uses a keyboard 16, mouse 18 or other such input devices to interact with computer 10 and the software running on it in the conventional manner.

Like ASIC design tool 12, a suitable circuit simulator 20, such as the well-known SPICE simulator, is also illustrated as running on computer 10, but like the other software described herein it can alternatively be run on a separate computer. SPICE is an acronym for Simulation Program with Integrated Circuit Emphasis and was inspired by the need to accurately model devices used in integrated circuit design. Originating at the University of California at Berkeley, it has now become the standard computer program for electrical and electronic simulation. As understood by persons skilled in the art to which the invention relates, commercial products embodying a SPICE simulator are widely available from a variety of EDA sources. Therefore, except as it specifically pertains to the present invention, the SPICE simulator is not described further in this patent specification. Although SPICE is used in the exemplary embodiment of the invention, in other embodiments other suitable simulators can be used.

Two novel software tools are also illustrated as running on computer 10: a current sink modeler 22 and a voltage droop modeler 24. These tools, too, can alternatively be run on one or more separate computers from those that run design tool 12, circuit simulator 20, etc. Also, in other embodiments of the invention, they can be combined with each other or with other software. Indeed, the four software elements illustrated in FIG. 1 are only shown as four individual elements for purposes of illustration and clarity; their functions, described in detail below, can be divided or distributed among any suitable number of software elements and combined with each other or with other software elements (not shown) in any suitable manner. They can have any suitable structure and can be embodied in any suitable programming language. Persons skilled in the art will readily be capable of writing or otherwise providing suitable programs, scripts or other software elements that embody the steps and other functions described below.

It should also be noted that, regardless of how the software elements of the present invention are structured, and where and in what form they are stored or transmitted, they have the characteristic of any “computer program product” in that they are carried on some storage medium (e.g., a removable disk 25, working memory, hard disk storage, etc.) or transmission medium from which a computer such as computer 10 can obtain the elements needed to perform the steps and other functions described herein. However, as persons skilled in the art will recognize, the software elements that effect the functions described herein need not exist in memory or on another medium simultaneously or in their entireties in the manner conceptually indicated in FIG. 1 (for purposes of illustration); rather, the relevant functional modules or other elements and portions thereof can be obtained and executed by computer 10 or other computer on an as-needed basis in the conventional manner. Note that although not shown for purposes of clarity, computer 10 includes, in addition to those elements described above, all conventional hardware and software elements of the types typically included in computers used for EDA and similar purposes, such as a processor, memory, interfaces, network card, etc.

Current Sink Modeling

Current sink modeler 22 operates based upon a presumption that the ASIC core (i.e., the most application-specific portion of the ASIC and that upon which an ASIC designer normally focuses) consists only of logic elements selected from among a small group of what are referred to in this patent specification as “standard cells.” This presumption is made for purposes of simplifying the method and enabling rapid current sink modeling at an early stage in the ASIC design process. The standard cell types of the group represent the types or categories of logic that are typically included in an ASIC core. For example, as illustrated in FIG. 2, in the exemplary embodiment of the invention this group of standard cell types consists of: a 2-input NAND gate 26, which is representative of all combinational logic in the ASIC core; a D flip-flop 28, which is representative of all sequential (register) logic in the ASIC core; and a clock buffer 30, which is representative of the local clock distribution elements in the ASIC core. Note that each standard cell has a capacitive load representative of conditions typical to an ASIC. For example, a 25 fF load can be applied to NAND gate 26, a 50 fF load to flip-flop 28, and a 90 fF load to clock buffer 30. Although these standard cell types are believed to be representative of the types or categories of logic that are typically included in an ASIC core, persons skilled in the art will recognize that they are only examples and that others may be suitable in addition or alternatively.

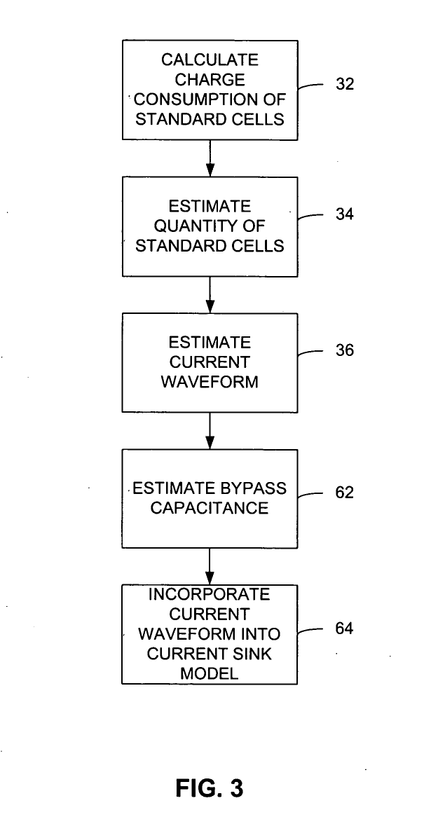

As illustrated in FIG. 3, the first step 32 in an exemplary method of providing a current sink model for the core region is to calculate the charge consumption of each standard cell using circuit simulator 20 or similar means. The output of a SPICE simulation will be a waveform representing current drawn over a predetermined time interval, or, equivalently, the charge consumed over the interval. The use of these waveforms is described below.

For each of the standard cells, multiple simulations are performed, each under a different condition, such as clock edge rising, clock edge falling, etc. The results for an exemplary set of conditions can include: charge consumed at rising clock edge while a register standard cell (e.g., flip-flop 28) is switching from 0 to 1 (referred to in the example below as “charge_reg_sw0to1_ck0to1”); charge consumed at falling clock edge while a register standard cell is switching from 0 to 1 (referred to in the example below as “charge_reg_sw0to1_ck1to0”); charge consumed at rising clock edge while a register standard cell is switching from 1 to 0 (referred to in the example below as “charge_reg_sw1to0_ck0to1”); and charge consumed at falling clock edge while a register standard cell is switching from 1 to 0 (referred to in the example below as “charge_reg_sw1to0_ck1to0”). Results under a still more inclusive set of exemplary conditions can further include, in addition to those set forth above: charge consumed by a register standard cell that is not switching at all at a rising clock edge (referred to in the example below as “charge_reg_ck0to1”); and charge consumed by a register standard cell that is not switching at all at a falling clock edge (referred to in the example below as “charge_reg_ck1to0”). Simulations for a buffer standard cell (e.g., clock buffer 30) can include charge consumed at rising edge (referred to in the example below as “charge_ckbuf0to1”); and charge consumed at falling edge (referred to in the example below as “charge_ckbuf1to0”). Simulations for the combinational logic standard cell (e.g., NAND gate 26) can include the various possible combinations of edge transitions at its inputs. A simplification made in the exemplary embodiment of the invention is to calculate and use only the average charge consumed by a combinational logic element under these conditions (referred to in the example below as “charge_nand2”).

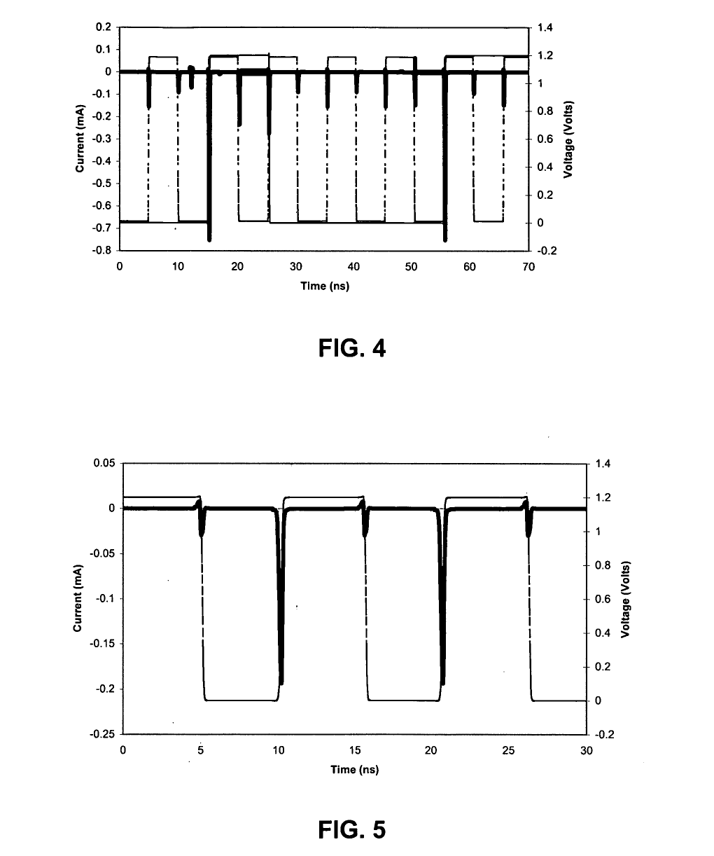

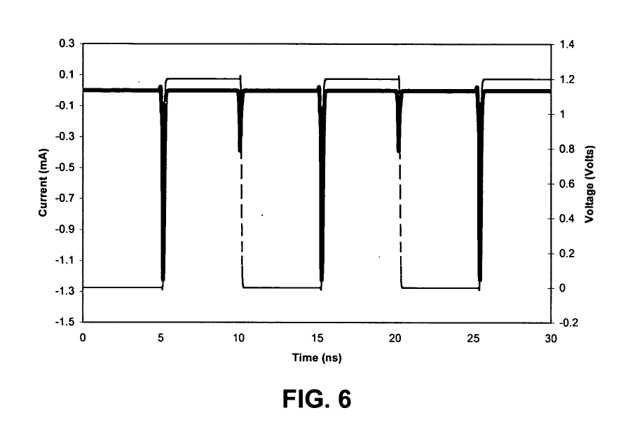

Examples of current waveforms that the above-described SPICE simulations can produce are shown in FIGS. 4-6. In the illustrated examples, the SPICE simulations were performed by having SPICE use the Nominal FET models for 2-input NAND gate 26, D flip-flop 28 and clock buffer 30, at a nominal voltage (i.e., 1.2 volts), and an ambient temperature of 55 degrees celsius. In FIG. 4, the current drawn from the power supply (V_{DD}) by flip-flop 28 is shown in heavy line, while the clock is shown with respect to voltage in thinner, dashed line, and its Q output shown with respect to voltage in thinner solid line. In FIG. 5, the current drawn from V_{DD} by NAND gate 26 is shown in heavy line, while its output is shown with respect to voltage in thinner, dashed line. Similarly, in FIG. 6, the current drawn from V_{DD} by clock buffer 30 is shown in heavy line, and its output shown with respect to voltage in thinner, dashed line.

Note that step 32 can be performed in advance of the steps that follow (described below) and the results stored for use at a later time, because the charge consumption (current) waveforms produced at step 32 can be used as relatively fixed inputs to a variety of further calculations in which the user may choose to vary other inputs. More generally, unless explicitly stated, the steps described herein can be performed in any suitable order and at any suitable time with respect to one another. As noted above, they can also be performed apart from one another, such as by using separate software tools on separate computers or by using other methods.

At step 34 in the exemplary method of providing a current sink model, the number of each type of standard cell in the ASIC core is estimated or otherwise determined. The method considers the ASIC core or other region of interest for which a current sink is to be modeled as consisting of a number of sub-regions (which may be referred to as “Core Units” in instances in which the region of interest is an ASIC core, as in this example). The estimate can be made in any suitable manner, but in the exemplary embodiment it is calculated based upon three parameters that a person having ordinary skill in the art will readily be capable of estimating: Core Unit Utilization (referred to below as “core_utilization”), which is the percentage of core unit area occupied by the standard cells as opposed to being unoccupied or occupied by something else; Core Unit Toggle Rate (referred to below as “core_toggle_rate”), which is the percentage of logic elements in the Core Unit that switch values, i.e., toggle, during any given clock cycle; and Core Unit Ratio of Combinational Logic Area to Non-Combinational Logic Area (referred to below as “core_ratio”). For example, although an ASIC designer may not have completed the logic design, he or she may know with some accuracy that: about 70% of the Core Unit will be occupied by logic elements of which the standard cells described above are representative; about 15% of those logic elements will switch states during any clock cycle; and that in the completed design there will be about twice as many combinational logic elements (of which 2-input NAND gate 26 is representative) as non-combinational logic elements (of which flip-flop 28 is representative). As persons skilled in the art will understand, these values can readily be estimated, but they will vary depending upon the characteristics of the ASIC design at issue. For example, an ASIC that performs a crossbar switching function may likely have a Core Unit Utilization lower than 70% because much of the area will be occupied by signal lines (routing). Current sink modeler 22 can include a suitable user interface for receiving the above-described parameters from the user as input.

In addition to the parameters set forth above, several other parameters are used in the exemplary method to determine the number of each type of standard cell in the ASIC core. These include: an estimate of the number of flip-flops 28 that can be driven by one clock buffer 30 (referred to below as “reg_per ckbuf”); the total area occupied by one D flip-flop 28 (referred to below as “area_per reg”); the total area occupied by one clock buffer 30 (referred to below as “area_per-ckbuf”); the total area occupied by one 2-input NAND gate 26 (referred to below as “area_per nand2”); and the total area of the Core Unit or other sub-region for which a current sink is to be modeled (referred to below as “core_unit_area”).

Based upon the parameters set forth above, the number of each type of standard cell in the ASIC core, as well as the number of those cells that are switching at any given time, can be estimated by performing the following calculations:
area_registers=(core_unit_area*core_utilization)/(core_ratio+1)
number_registers=area_registers/area_per_reg
number_ckbufs=number_registers/reg_per_ckbuf
area_nand2=[(core_unit_area*core_utilization)−(number_ckbufs* area_per_ckbuf)]/[(1/core_ratio)+1]
number_nand2=area_nand2/area_per_nand2
number_reg_switch=number_registers*core_toggle_rate
number_nand2_switch=number_nand2*core_toggle_rate

At step 36 in the exemplary method, the current waveform is then determined from the values calculated above and modeled as a triangular wave for purposes of convenience and expediency. In other embodiments, the current waveform can be modeled in any other suitable manner. The method considers each clock period as divided into a suitable number (N) of equal time segments, such as ten. For example, in an ASIC design in which the core clock frequency is 250 MHz (i.e., a clock period of 4000 ps), each of the ten time segments has a length (referred to below as “segment_time”) of 400 ps. In each time segment, the current rises from zero to its peak in half the time segment, and then drops from the peak back to zero in the other half, resulting in a triangular wave.

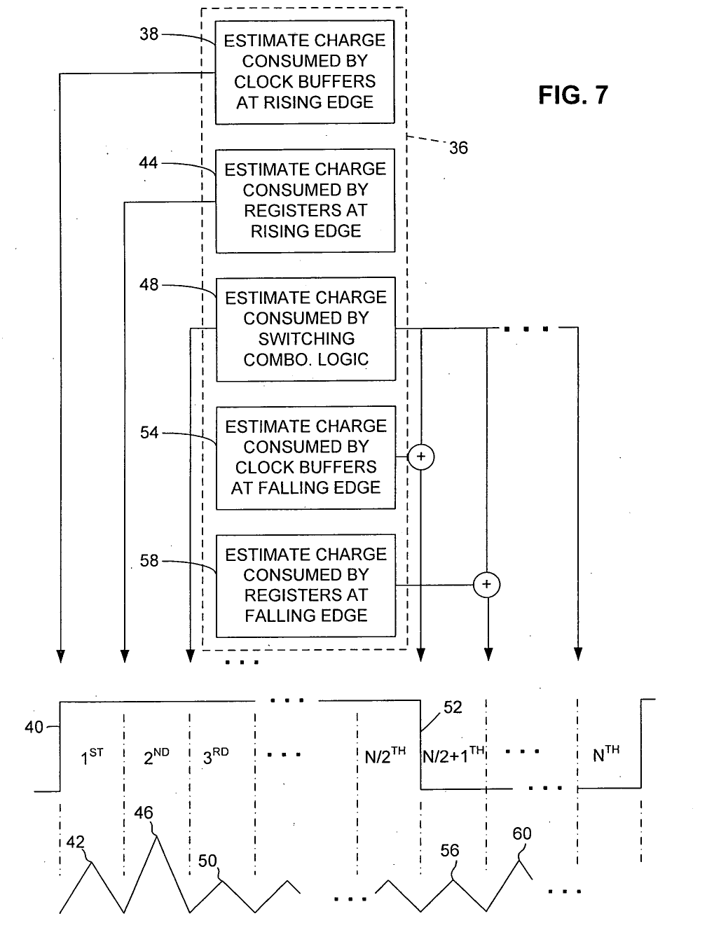

Step 36 is illustrated in FIG. 7 in further detail, broken into exemplary sub-steps. At (sub)-step 38, the current in the first segment of the waveform is determined. As noted above, the first segment begins at the rising edge 40 of the clock. Thus, the current in the first segment can be attributed to the charge consumed by the local clock buffer at the rising edge of the clock. The average current in the first segment is first calculated:
avg_current_ckbuf_rising=(charge_ckbuf0to1*number_ckbufs)/segment_time

Then, the peak current 42 in the first segment is determined for the purpose of defining the triangular waveform. Peak current 42 is twice the average current (avg_current_ckbuf_rising) in the first segment.

At step 44, the current in the second segment of the waveform is determined. The average current in the second segment can be attributed to the charge consumed by registers that are switching following the rising edge of the clock. To simplify the calculations in the exemplary method for purposes of convenience and expediency, it is presumed that half the registers that are switching are switching from 0 to 1, and half are switching from 1 to 0. The average current in the second segment can then be calculated as follows:
charge_reg_sw_ck0to1=(charge_reg_sw0to1_ck0to1+(charge_reg_sw1to0_ck0to1)/2
avg_current_reg_rising=[(charge_reg_sw_ck0to1*number_reg_switch)+(charge_reg_ck0to1*(number_register_number_reg_switch))]/segment_time

Then, the peak current 46 in the second segment is determined by doubling the average current (avg_current_reg_rising ) in the second segment.

The current in all remaining segments (in this example, segments 3-10) can be attributed at least in part to the charge consumed by the switching of combinational logic. At step 48, the charge consumed by the switching of combinational logic is determined and divided equally among the remaining segments (3-N), with the charge consumed in the last (N^{TH}) segment presumed to be zero:
avg_current_nand2=(number_nand2_switch*charge_nand2)/(segment_time*number_segments−3))

Thus, the peak current 50 in the third segment is two times avg_current_nand2. The average and peak currents in segments 4-N/2 can be determined in the same way.

The falling edge 52 of the clock occurs following the N/2^{TH} segment, i.e., the middle of the clock period. At step 54, the current in the (N/2+1)^{TH} segment (in this example, the sixth segment) of the waveform is determined. The average current in this segment can be attributed to the charge consumed by both a portion of the switching combinational logic, as described above with regard to step 48, plus the charge consumed by the local clock buffer at falling edge 52:
avg_current_ckbuf_falling=[(charge_ckbuf1to0*number_ckbufs)/segment_time]+avg_current_nand2

Thus, the peak current 56 in the third segment is two times avg_current_ckbuf_falling.

At step 58, the current in the segment following that at the middle of the clock period (in this example, the seventh segment) is determined. The current in this segment can be attributed to the charge consumed by both a portion of the switching combinational logic, as described above with regard to step 48, plus the charge consumed by registers at falling edge 52 of the clock. As in step 44, it is presumed that half the registers that are switching are switching from 0 to 1, and half are switching from 1 to 0. The average current in this (N/2+1)^{TH} segment can thus be calculated as follows:
charge_reg_sw_ck1to0=(charge_reg_sw0to1_ck1to0+charge_reg_sw1to0_ck1to0)/2
avg_current_reg_falling=[((charge_reg_sw_ck1to0*number_reg_switch)+(charge_reg_ck1to0*(number_register−number_reg_switch)))/segment_time]+avg_current_nand2

Thus, the peak current 60 in this segment is two times avg_current_reg_falling. The average and peak currents in all remaining segments through the N^{TH} (in this example, the tenth) can be determined in the same way as described above for segments 3-N/2. With the peaks calculated as described above, and with the presumption that the current rises from zero to its peak in half the time segment, and then drops from the peak back to zero in the other half, the segments can be appended together to produce a triangular-wave current waveform of the type shown at the bottom of FIG. 7. Note that the waveforms described herein can be represented in any suitable data structure or other form; the term “waveform” is used for convenience and is not intended to limit the data to a visually perceptible form.

Returning to FIG. 3, an additional step 62 of estimating bypass capacitance can be performed. Bypass capacitance is not part of the current sink model itself but is commonly used in conjunction with it, as described below. Therefore, in some embodiments of the invention, a step of estimating bypass capacitance such as step 62 can be performed. Bypass capacitance includes both intrinsic bypass capacitance (Cᵢₙₜᵣ) of the logic circuit elements in the Core Unit or other region of interest and any additional bypass capacitance the ASIC designer may choose to add (C_{add}). Intrinsic bypass capacitance can be calculated as follows:

Cᵢₙₜᵣ=(number_ckbufs*C_ckbufᵢₙₜᵣ)+(number_registers*C_registerᵢₙₜᵣ)+(number_nand2*C_nand2ᵢₙₜᵣ), where C_ckbufᵢₙₜᵣ is the intrinsic bypass capacitance per clock buffer 30, C_registerᵢₙₜᵣ is the intrinsic bypass capacitance per flip-flop 28, and C_nand2ᵢₙₜᵣ is the intrinsic bypass capacitance per NAND gate 26.

Lastly, at step 64 the current waveform (data) is incorporated or transformed into a current sink model having a format compatible with ASIC design tool 12, circuit simulator 20 or other tool with which the current sink model is to be used. Persons skilled in the art are familiar with such tools and with creating or otherwise providing current sink models and other component models for use with such tools. Therefore, the steps involved in transforming the data into a usable model are not described herein. Once the model has been created, it can be stored and used as needed by the ASIC designer in simulations or for other purposes. For example, the section below describes using the current sink model in voltage droop analysis.

Voltage Droop Analysis

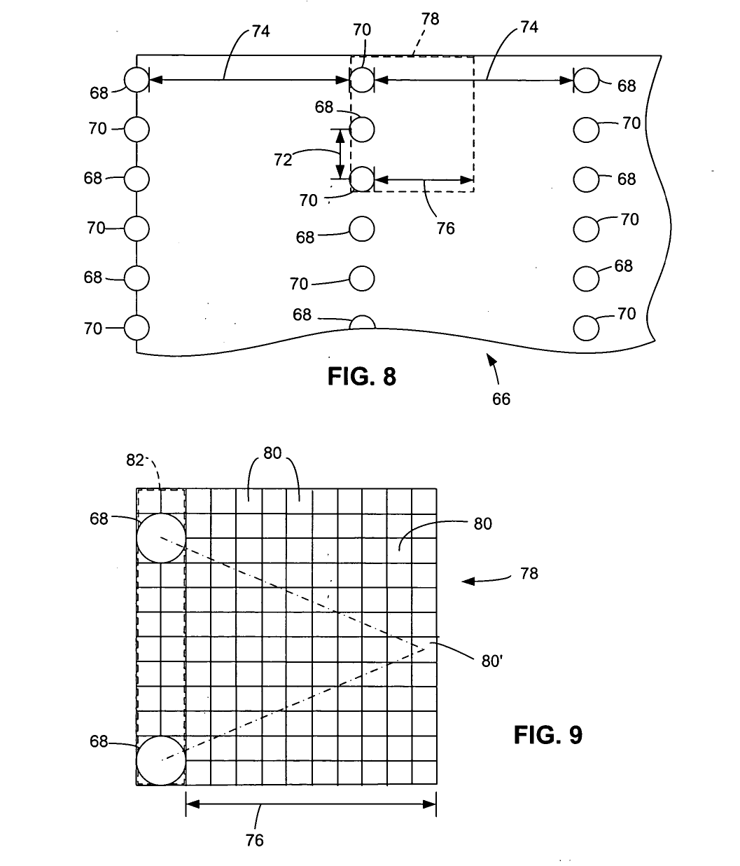

As illustrated in FIG. 8 (not to scale), the ASIC core 66 includes supply voltage (V_{DD}) solder bumps 68 and ground solder bumps 70, arranged in an alternating manner in multiple columns on the surface of the semiconductor chip material. This arrangement is provided as an example for purposes of illustration, and the invention can be used in ASIC designs in which the bumps are arranged differently or in which the connection means comprises something other than bumps. In the illustrated arrangement, adjacent bumps within a column are separated by some spacing 72, and adjacent columns are separated by some spacing 74. For purposes of reference only, so that one can appreciate the scale involved, values for spacings 72 and 74 can be, for example, 202.4 microns (μ) and 2112 μ, respectively. These values are provided solely for purposes of illustration, and the invention can be used with ASIC and other integrated circuit designs having any suitable spacings and arrangements. Nevertheless, it is useful to note that persons skilled in the art will be able to obtain specifications describing design parameters such as minimum recommended bump spacing as well as specifications describing the properties of the materials from which the chip will be fabricated from the party charged with fabricating the chip, who produces the specifications in response to empirical testing and other means well-known in the art.

Although the present invention can be used to analyze voltage droop anywhere on a chip, a chip designer may be most interested in performing a worst-case analysis. Thus, the designer would focus the analysis upon the areas of the chip in which voltage drop is likely to be greatest. Voltage droop is likely to be greatest at a point on the chip the greatest distance away from a bump 68 or 70. As a result of the bump arrangement described above, the greatest voltage drop is likely to occur mid-way between two adjacent columns, i.e., at a distance 76 from the nearest column.

In an exemplary embodiment of the invention, a square region 78 having sides with a dimension of approximately distance 76 is analyzed. For reasons discussed below, distance 76 is one-half of spacing 74. For purposes of convenience and expediency in the exemplary embodiment, it is presumed that the supply (V_{DD}) distribution network and the ground distribution network are identical. In accordance with this presumption, only the supply distribution network in the region 78 is analyzed, and the results of the voltage droop simulation are doubled to arrive at a final estimate of voltage droop for the combined supply and ground distribution network.

As illustrated in FIG. 9 (not to scale), region 78 is considered to comprise a number of sub-regions 80, arranged in a tiled or mosaic manner over the entire region 78. In an instance in which the region of interest is the ASIC core, as in this example, those sub-regions 80 that occupy the core area can be referred to alternatively as Core Units. Although in the exemplary embodiment region 78 and sub-regions 80 are square for purposes of convenience, in other embodiments they can have other suitable shapes and sizes. The worst-case voltage droop is likely to occur at the sub-region 80′ that is farthest from the each of the nearest supply voltage bumps 68 (and thus equidistant between them, as indicated by the dashed lines in FIG. 9). The method described below simulates the voltage droop in sub-region 80′ or any other sub-region 80 that the user selects.

The simulation can be performed relatively quickly as well as early in the design process, before the circuit design has been completed, because it is based upon a presumption that all sub-regions 80 are substantially identical with regard to the supply voltage lines in them. In some instances, all sub-regions 80 may not be exactly identical. For example, sub-regions 80 occupied by the columns of bumps 68 may differ from those elsewhere in region 78. In some ASIC designs, the portion of one of the metal layers underneath the bump columns is dedicated entirely to the supply voltage, while the portion of the same layer that occupies the core area follows the normal layout of supply voltage lines (e.g., as specified by the ASIC manufacturer). Such an arrangement is illustrated in FIG. 9, where the group 82 of sub-regions 80 occupied by bumps 68 have such a metal layer dedicated to the supply voltage.

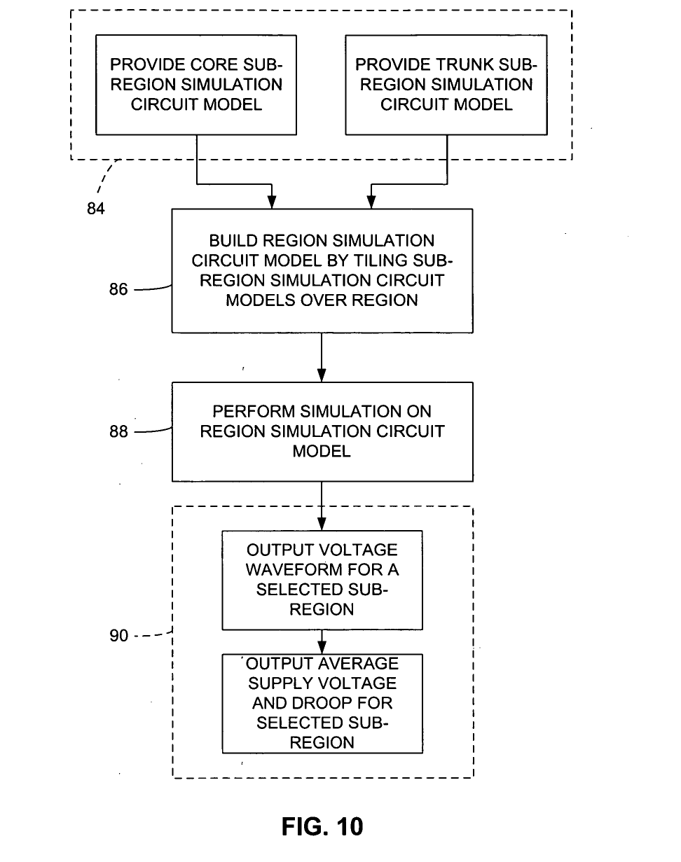

As illustrated in FIG. 10, an exemplary method for modeling voltage droop on an ASIC comprises a first step 84 of modeling sub-regions 80. As sub-regions 80 are presumed identical in the relevant respects, a sub-region simulation circuit model representative of each of them is created. The sub-region simulation circuit model represents the portion of the supply voltage distribution network that exists within each sub-region 80. In the exemplary ASIC illustrated in FIGS. 8-9, the sub-region simulation circuit model for each of sub-regions 80 in one of the supply voltage bump columns (i.e., in group 82) can be referred to alternatively as a Trunk Unit model, whereas the model for each of the remaining sub-regions 80 (i.e., those in the ASIC core) can be referred to alternatively as a Core Unit model. Both a Core Unit model and Trunk unit model are provided at step 84 in this example. In other examples, such as those in which the region of interest is not an ASIC core, the sub-region simulation circuit models provided at such a step may be different, and there may be more than two or there may be only one.

At step 86, a region simulation model for the entire region 78 is created. In the exemplary embodiment of the invention, this is done by connecting the sub-region simulation circuit models together in accordance with the tiled manner in which sub-regions 80 fit together in FIG. 9. For example, one copy of the sub-region simulation circuit model that corresponds to one sub-region 80 can be connected in simulated electrical connection with another copy corresponding to an adjacent sub-region 80. (Depending upon the manner in which circuit simulator 20 represents the circuit under simulation, there may be actual copies of the corresponding data in memory, or there may be multiple references to a single instance of the data; regardless of the actual manner in which circuit simulator 20 organizes its internal data, for purposes of convenience this step is described herein as though the circuit models are copied, and the term “tiled” and similar terms are intended to include within their scope all such equivalents.) The result is that the simulated supply voltage lines in each sub-region 80 are in simulated electrical contact with those in an adjacent sub-region 80. In this manner, the current (and corresponding voltages) through the distribution network from one sub-region 80 to the next, throughout region 78, can be simulated. The sub-region simulation circuit models and the manner in which they are interconnected in the region simulation circuit model are described below in further detail.

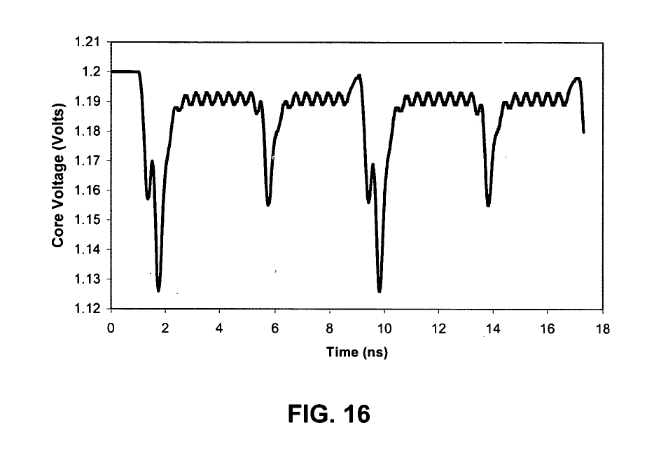

At step 88, such a simulation is performed on the resulting region simulation circuit model using (SPICE) circuit simulator 20 (see FIG. 1). As described below in further detail, the ASIC designer or other user can select a node within any of the interconnected sub-region simulation circuit models and, at step 90, view the voltage waveform at that node, an example of which is illustrated in FIG. 16. As the nominal supply voltage (V_{DD}) in this example is 1.2 V, the extent to which the voltage at times falls below this value represents what is known as voltage droop. The user can also perform other operations upon the output voltage waveform, such as calculating the average core voltage at the selected node by integrating the voltage waveform over one clock period and dividing the result by the clock period. Similarly, the user can obtain the average core voltage droop at the selected node by subtracting the average core voltage from the nominal supply voltage.

Some or all of steps 84-90 can be effected by voltage droop modeler 24. Voltage droop modeler 24 can, for example, comprise a script that controls ASIC design tool 12 or circuit simulator 20 in a manner that causes the region circuit simulation model to be built, and then controls circuit simulator 20 in a manner that causes the simulation to run and the results to be output. Accordingly, voltage droop modeler 20 can include a suitable user interface for receiving as input such information as the user's selection of a node at which to observe the voltage, the bump spacing, and the number of lines on each layer that carry the supply voltage, as well as any or all of the parameters described above with regard to current sink modeler 12, such as Core Unit Utilization, Core Unit Toggle Rate, Core Unit Ratio of Combinational Logic Area to Non-Combinational Logic Area, and Clock Frequency, as the above-described current sink model is included in the sub-region simulation circuit model as described below in further detail. Although current sink modeler 12 and voltage droop modeler 20 are described herein as separate software tools for purposes of illustration, in some embodiments they can readily be combined, use a common user interface, or otherwise co-operate with each other.

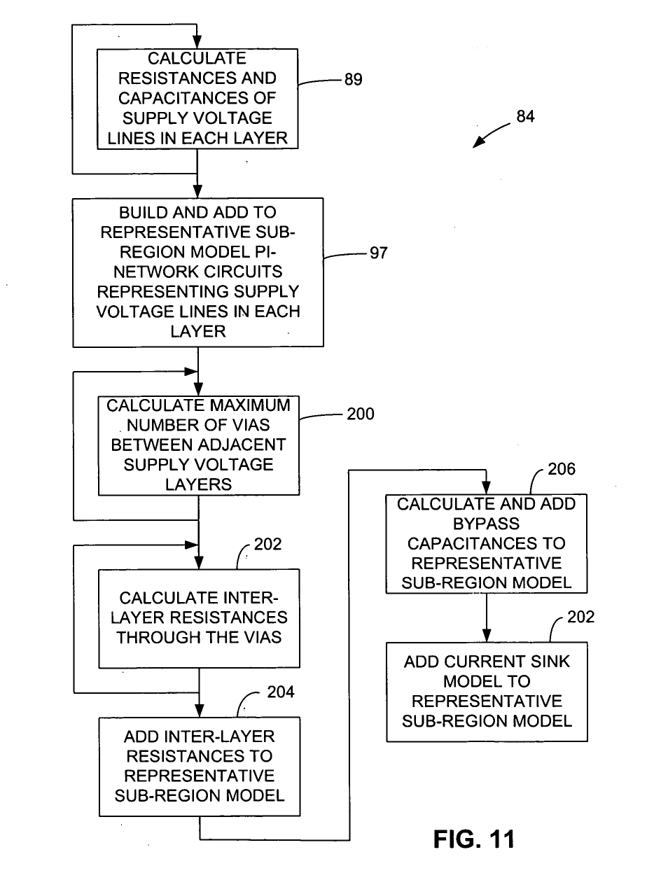

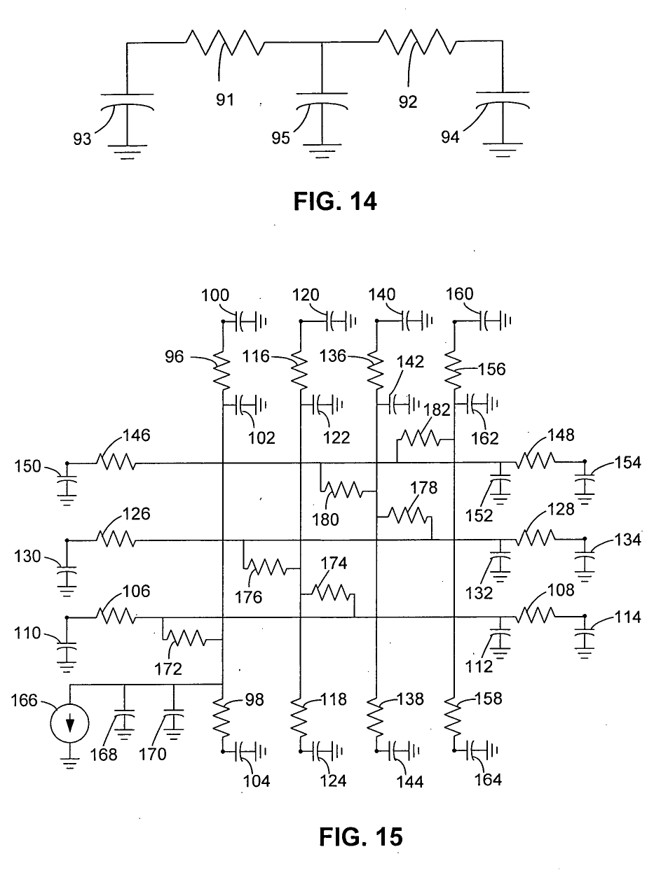

Step 84 is illustrated in further detail in FIG. 11. At (sub)-step 89, the resistances and capacitances of the supply voltage lines in each layer are determined. A wire can be modeled as a pi network in which the total resistance of the line is distributed over a number of resistors, and the total capacitance of the line is distributed over a number of capacitors, as known in the art. Thus, as illustrated in FIG. 14, a supply voltage line of a sub-region simulation circuit model can be modeled as a pi network in which each of two resistors 91 and 92 has a resistance value of one-half the total resistance of the line, each of two capacitors 93 and 94 has a capacitance value of one-fourth the total capacitance of the line, and another capacitor 95 has a capacitance value of one-half the total capacitance of the line. The resistance and capacitance of a supply voltage line (metal) per unit area (e.g., per square micron), is generally included in the specifications provided by the party charged with manufacturing the ASIC or otherwise readily obtainable from other sources by persons skilled in the art. The capacitance can be the nominal capacitance to adjacent layers, ignoring any side capacitance.

Returning briefly to FIG. 11, at step 97 the representative sub-region simulation circuit model is built, based largely upon the above-described pi-network circuit configuration but accounting for all layers of the ASIC within the representative sub-region that carry supply voltage lines. Such a representative sub-region simulation circuit model is shown in FIG. 15.

As illustrated in FIG. 15, the model includes: resistors 96 and 98, each representing half the total resistance of the supply voltage lines on the second layer; capacitors 100, 102 and 104, together representing the total capacitance of the supply voltage lines on the second layer, with capacitor 102 representing half the total and capacitors 100 and 104 each representing one-fourth the total; resistors 106 and 108, each representing half the total resistance of the supply voltage lines on the third layer; capacitors 110, 112 and 114, together representing the total capacitance of the supply voltage lines on the third layer, with capacitor 112 representing half the total and capacitors 110 and 114 each representing one-fourth the total; resistors 116 and 118, each representing half the total resistance of the supply voltage lines on the fourth layer; capacitors 120, 122 and 124, together representing the total capacitance of the supply voltage lines on the fourth layer, with capacitor 122 representing half the total and capacitors 120 and 124 each representing one-fourth the total; resistors 126 and 128, each representing half the total resistance of the supply voltage lines on the fifth layer; capacitors 130, 132 and 134, together representing the total capacitance of the supply voltage lines on the fifth layer, with capacitor 132 representing half the total and capacitors 130 and 134 each representing one-fourth the total; resistors 136 and 138, each representing half the total resistance of the supply voltage lines on the sixth layer; capacitors 140, 142 and 144, together representing the total capacitance of the supply voltage lines on the sixth layer, with capacitor 142 representing half the total and capacitors 140 and 144 each representing one-fourth the total; resistors 146 and 148, each representing half the total resistance of the supply voltage lines on the seventh layer; capacitors 150, 152 and 154, together representing the total capacitance of the supply voltage lines on the seventh layer, with capacitor 152 representing half the total and capacitors 150 and 154 each representing one-fourth the total; resistors 156 and 158, each representing half the total resistance of the supply voltage lines on the eighth layer; and capacitors 160, 162 and 164, together representing the total capacitance of the supply voltage lines on the eighth layer, with capacitor 162 representing half the total and capacitors 160 and 164 each representing one-fourth the total.

The illustrated sub-region simulation circuit model also includes a current sink model 166 and bypass capacitors 168 and 170. Bypass capacitors 168 and 170 represent intrinsic bypass capacitance and added bypass capacitance, respectively. Current sink model 166 and capacitor 168 can be of the types described above with regard to current sink modeling and can be created in the manner described above or, in other embodiments of the invention, they can be of any other suitable type and created or otherwise provided in any other suitable manner.

The selected node at which the exemplary voltage waveform shown in FIG. 16 is obtained can be the non-grounded node to which current sink model 166 is coupled, as the supply voltage droop experienced at that node is representative of the supply voltage droop that logic elements in the sub-region will experience.

The remaining resistors 172, 174, 176, 178,180 and 182 in the sub-region simulation circuit model represent inter-layer contact resistances, i.e., resistances between neighboring supply voltage lines in contact with each other in neighboring layers in the representative sub-region. Resistor 172 represents the contact resistance between the second and third layer supply voltage lines; resistor 174 represents the contact resistance between the third and fourth layer supply voltage lines; resistor 176 represents the contact resistance between the fourth and fifth layer supply voltage lines; resistor 178 represents the contact resistance between the fifth and sixth layer supply voltage lines; resistor 180 represents the contact resistance between the sixth and seventh layer supply voltage lines; and resistor 182 represents the contact resistance between the seventh and eighth layer supply voltage lines.

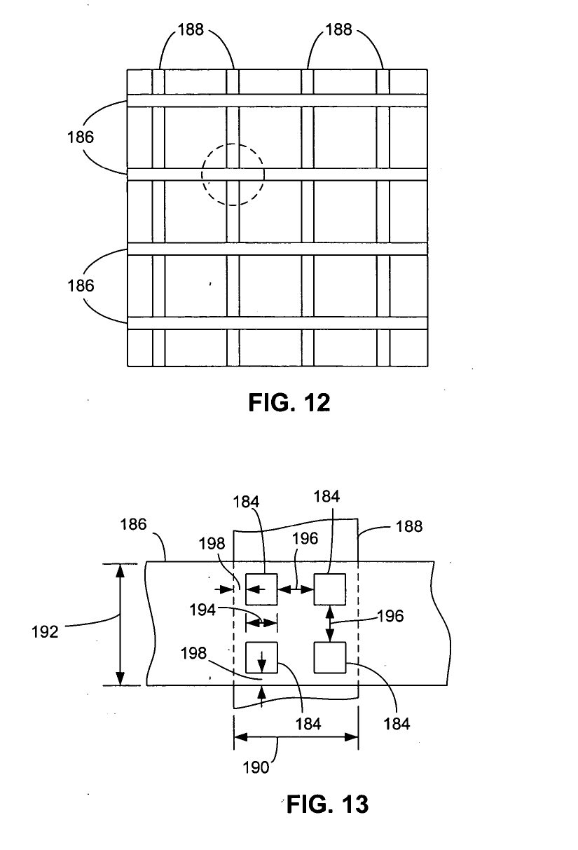

As illustrated in FIGS. 12-13 (not to scale), the inter-layer contact resistances depend upon the number of vias 184 that are included in the design to connect the supply voltage lines 186 of one layer with the supply voltage lines 188 of an adjacent layer. As illustrated in FIG. 12, an ASIC designer can choose to place one or more vias 184 in the areas where the supply voltage lines 186 of one layer overlap the supply voltage lines 188 of an adjacent layer. In the illustrated example, there are 16 such areas of overlap within the representative sub-region. One such area is indicated by a dashed-line circle, and an enlargement of the encircled area is shown in FIG. 13.

Inter-layer contact resistances are calculated based upon a presumption that the maximum possible number of vias that can be fit in the areas of supply voltage line overlap (within specified tolerances) are placed in those areas. In the following calculations, the following tolerances and other parameters, shown in FIG. 13, are used:

Vertical Metal Width 190: This dimension is the width of the supply voltage line 188 that is oriented in a vertical direction (with respect to whatever frame of reference the ASIC designer may choose to use).

Horizontal Metal Width 192: This dimension is the width of the supply voltage line 186 that is oriented in a horizontal direction (with respect to whatever frame of reference the ASIC designer may choose to use).

Via Width 194: This dimension is the width (and length) of a via 184. In this example, vias 184 are shown as having a square shape, but the calculations can be modified for other via shapes that may be known in the art.

Via Space 196: This dimension is the minimum spacing between adjacent vias that is recommended by the party charged with manufacturing the ASIC.

Via Extension 198: This dimension is the minimum spacing recommended by the ASIC manufacturer between an edge of a via 184 and an adjacent edge of a supply voltage line on which the via 184 is placed. The ASIC manufacturer typically determines the Via Space and Via Extension specifications by empirical testing or similar means and publishes them along with other specifications in which ASIC designers may be interested.

To calculate the maximum number of vias, following inequalities are used:
Vertical Metal Width−[Via Width+(2×Via Extension)+Nₓ×(Via Width+Via Space)]≧0
Horizontal Metal Width−[Via Width+(2×Via Extension)+N_{y}×(Via Width+Via Space)]≧0

Referring briefly again to FIG. 11, at step 200 the maximum number of vias between two adjacent supply voltage layers is calculated. First, the above two inequalities are used to solve for the maximum values for Nₓ and N_{y}. Then, the following equation is used to calculate the maximum number of contacts at an area where to supply voltage lines on adjacent layers overlap:
Maximum Number of Contacts=(Nₓ+1)×(N_{y}+1)

For example, in an instance in which the vertical supply voltage lines are 0.64 μ wide, the horizontal supply voltage lines are 0.90 μ wide, the via width is 0.19 μ, the minimum recommended via spacing (Via Space) is 0.22 μ, and the minimum recommended via extension (Via Extension) is 0.005 μ, solving the inequalities produces a value of one (1) for both Nₓ and N_{y}. Thus, the Maximum Number of Contacts is four. In the case of the sub-region shown in FIG. 12, the total number of contacts between the two layers shown can be found by multiplying the Maximum Number of Contacts by 16 because there are 16 areas of supply voltage line overlap between the two layers. Thus, the total number of contacts (vias 184) between the two layers shown is 64 in this example.

The resistance of a single via 184 is another specification that, like those mentioned above, is known to the party charged with manufacturing the ASIC. Returning to FIG. 11, at step 202 the total resistance of all contacts between supply voltage lines of the two layers can be determined by dividing the resistance of a single via 184 by the total number of contacts between the two layers.

As each of resistors 172-182 (FIG. 15) represents the total resistance of all contacts between supply voltage lines of two layers, the above-described calculations are repeated for each of resistors 172-182.

At step 204, resistors 172-182 are added to the sub-region model. Similarly, at steps 206 and 208, bypass capacitors 168 and 170 and current sink model 166, respectively, are added to the sub-region model. These steps can be performed at any suitable time with respect to other steps described above and are shown following steps 92, 94, 200 and 202 solely for purposes of illustration and completeness. The building of the sub-region model in this manner completes step 84 (FIG. 10) of the overall method of providing a voltage model for the ASIC core or other region. With regard to step 84, note that the modeling of a Trunk Unit differs from the above-described modeling of a Core Unit only in that the inter-layer resistances for a Trunk Unit will be lower than those for a Core Unit because the supply voltage lines underneath the supply voltage bumps (see FIGS. 8-9) are wider than those within a Core Unit.

Note that when step 86 (FIG. 10) of tiling sub-region models together to form the region model is performed, the nodes at the left side of FIG. 15 in one sub-region model become connected to the nodes at the right side of FIG. 15 in an adjacent sub-region model, and the nodes at the top of FIG. 15 in one sub-region model become connected to the nodes at the bottom of FIG. 15 in an adjacent sub-region model. The nodes are indicated by dots in FIG. 15. For example, the node between resistor 146 and capacitor 150 at the left side of FIG. 15 in one sub-region model becomes connected to the node between resistor 148 and capacitor 154 at the right side of FIG. 15 in an adjacent sub-region model. Similarly, the node between resistor 96 and capacitor 100 at the top of FIG. 15 in one sub-region model becomes connected to the node between resistor 98 and capacitor 104 at the bottom of FIG. 15 in an adjacent sub-region model.

It will be apparent to those skilled in the art that various modifications and variations can be made to this invention without departing from the spirit or scope of the invention. For example, although the illustrated embodiment of the invention relates to modeling and simulating elements of an ASIC, the invention can be applied to any other suitable type of integrated circuit. Thus, it is intended that the present invention cover all modifications and variations of this invention that they come within the scope of one or more claims and their equivalents. With regard to the claims, no claim is intended to invoke the sixth paragraph of 35 U.S.C. Section 112 unless it includes the term “means for” followed by a participle.

What is claimed is:

1. A method for providing a voltage model for a region of an integrated circuit chip, comprising the steps of:
providing a region simulation circuit model of the region to an electronic simulator tool, the region simulation circuit model comprising a plurality of tiled, substantially identical sub-region simulation circuit models, each sub-region simulation circuit model representing the supply voltage distribution network in a representative one of a plurality of substantially identical corresponding sub-regions of the region, each sub-region simulation circuit model comprising resistors and capacitors representative of resistances and capacitances of supply voltage lines in the representative sub-region based upon supply voltage line layout in the representative sub-region and predetermined resistance and capacitance per unit area of the chip; and
using the electronic simulator tool to determine a supply voltage waveform at a node in one of the plurality of sub-region simulation circuit models.

2. The method claimed in claim 1, wherein the step of using the electronic simulator tool to determine a voltage waveform at a node in one of the plurality of sub-region simulation circuit models comprises selecting one of the plurality of sub-region simulation circuit models.

3. The method claimed in claim 1, wherein the step of using the electronic simulator tool to determine a supply voltage waveform at a node in one of the plurality of sub-region simulation circuit models comprises calculating an average supply voltage at the node by integrating the voltage waveform over one clock period to obtain an integration result and dividing the integration result by the clock period.

4. The method claimed in claimed 3, further comprising the step of determining an average supply voltage droop at the node by subtracting the average supply voltage at the node from a predetermined supply voltage value.

5. The method claimed in claim 1, wherein the resistors and capacitors representative of resistances and capacitances of supply voltage lines in the representative sub-region are arranged substantially in a pi configuration.

6. The method claimed in claim 1, wherein each sub-region simulation circuit model further includes resistors representative of resistances of neighboring supply voltage lines in contact with each other in neighboring layers in the representative sub-region.

7. The method claimed in claim 6, wherein each sub-region simulation circuit model includes a maximum number of contacts between adjacent supply voltage lines in adjacent layers in the representative sub-region, and the step of providing a region simulation circuit model of the region comprises calculating the maximum number of contacts and a total resistance of the contacts.

8. The method claimed in claim 1, wherein each sub-region simulation circuit model includes a current sink model representing current drawn by circuitry in the representative sub-region, and the step of providing a region simulation circuit model of the region comprises providing the current sink model.

9. The method claimed in claim 8, wherein the step of providing the current sink model comprises:
determining charge consumption under each of a predetermined plurality of conditions for a standard cell of each type of a predetermined group of standard cell types;
determining a quantity of standard cells of each type in the representative sub-region;
determining a current waveform in response to charge consumption and quantity of standard cells of each type in the representative sub-region during each of a plurality of waveform segments; and
using an electronic design tool to provide a current sink model having the determined current waveform.

10. A computer program product for providing a supply voltage model on a region of an integrated circuit chip, the program being carried on a computer-usable medium, the program comprising:
a code segment for providing a region simulation circuit model of the region to an electronic simulator tool, the region simulation circuit model comprising a plurality of tiled, substantially identical sub-region simulation circuit models, each sub-region simulation circuit model representing the supply voltage distribution network in a representative one of a plurality of substantially identical corresponding sub-regions of the region, each sub-region simulation circuit model comprising resistors and capacitors representative of resistances and capacitances of supply voltage lines in the representative sub-region based upon supply voltage line layout in the representative sub-region and predetermined resistance and capacitance per unit area of the chip; and
a code segment for determining a supply voltage waveform at a node in one of the plurality of sub-region simulation circuit models.

11. The computer program product claimed in claim 10, wherein the code segment for providing a region simulation circuit model of the region to an electronic simulator tool comprises a code segment for receiving user input representing a user-selected number of supply voltage lines in a layer in the representative sub-region.

12. The computer program product claimed in claim 10, further comprising a code segment for calculating an average supply voltage at the node by integrating the voltage waveform at the node over one clock period to obtain an integration result and dividing the integration result by the clock period.

13. The computer program product claimed in claimed 12, further comprising a code segment for determining an average voltage droop at the node by subtracting the average supply voltage at the node from a predetermined supply voltage value.

14. The computer program product claimed in claim 10, wherein each sub-region simulation circuit model further includes resistors representative of resistances of neighboring supply voltage lines in contact with each other in neighboring layers in the representative sub-region.

15. The computer program product claimed in claim 14, wherein each sub-region simulation circuit model includes a maximum number of contacts between adjacent supply voltage lines in adjacent layers in the representative sub-region, and the code segment for providing a region simulation circuit model of the region comprises a code segment for calculating the maximum number of contacts and a total resistance of the contacts.

16. The computer program product claimed in claim 10, wherein each sub-region simulation circuit model includes a current sink model representing current drawn by circuitry in the representative sub-region, and the code segment for providing a region simulation circuit model of the region comprises a code segment for providing the current sink model.

17. The computer program product claimed in claim 16, wherein the code segment for providing the current sink model comprises:
a code segment for determining charge consumption under each of a predetermined plurality of conditions for a standard cell of each type of a predetermined group of standard cell types;
a code segment for determining a quantity of standard cells of each type in the representative sub-region; and
a code segment for determining a current waveform in response to charge consumption and quantity of standard cells of each type in the representative sub-region during each of a plurality of waveform segments.
